(19) United States
(12) Patent Application Publication
(10) Pub. No.: US 2006/0085335 A1
(43) Pub. Date: Apr. 20, 2006

(54) Point of sale systems and methods for consumer bill payment

(75) Inventors: Erik S. Crawford, Parker, CO (US); Thomas B. Sayor, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/969,767

(22) Filed: Oct. 19, 2004

(51) Int. Cl. G06Q 40/00

(52) U.S. Cl. 705/40

(57) ABSTRACT

The present invention provides systems and methods of processing bill payments. One such method includes receiving a payment request from a customer. The payment request is for a bill associated with a vendor. The vendor may be any number of vendors including utility companies, mortgage lenders, credit card companies, financing companies for the purchase of furniture, appliances, or automobiles, and the like. The method includes verifying, using a point-of-sale device, whether the vendor is included in a group of authorizing vendors. A customer identification and a payment amount associated with the particular bill is received from the customer. The method further includes receiving a payment authorization and providing a receipt to the customer. In this manner, the customer may use a point-of-sale device to make on-time bill payments.

### BACKGROUND OF THE INVENTION

The present invention relates generally to the field of bill payments, and in particular to the payment of bills using point-of-sale systems.

Traditionally, companies that provide goods or services bill their customers on a regular basis, e.g., monthly. The bills are typically printed on paper and mailed to the customer, who then usually returns payment by mail. The customer payment is typically by check or money order, although recently some companies accept credit card payments.

With the advent of the Internet, a variety of electronic bill payment services have become available. Such services typically require a customer to provide information on one or more accounts that are to be serviced. The bill payment service is then able to arrange with the service provider for the transfer of appropriate data. The data is organized and provided to the customer in a web page, so that the customer may authorize payments. Another type of bill payment service is the Western Union Convenience Pay® service that permits utility bills to be paid at an agent location. To pay the bill, the customer provides the agent with the bill statement and cash to make the payment. Western Union collects the money, enters the account information from the bill statement into a terminal, and then makes the payment electronically through the Western Union Money Transfer System. The present invention provides still further methods of making bill payments.

### BRIEF SUMMARY OF THE INVENTION

The present invention relates generally to the field of bill payments, and in particular, to system and methods for more easily paying bills, such as utility bills, by a consumer using point-of-sale systems.

The present invention provides methods of processing bill payments. In one such embodiment, the method includes receiving a payment request from a customer. The payment request is for a bill associated with a vendor. The vendor may be any number of vendors including utility companies, mortgage lenders, credit card companies, financing companies for the purchase of furniture, appliances, or automobiles, and the like. The method includes verifying, using a point-of-sale device, whether the vendor is included in a group of authorizing vendors. An authorizing vendor, in one embodiment, is a vendor, merchant, lender, creditor, or the like that is willing to accept payments from the customer at point-of-sale terminals, or other remote locations, including those operated by third parties. A customer identification and a payment amount associated with the particular bill is received from the customer. The method further includes receiving a payment authorization and providing a receipt to the customer. In this manner, the customer may use a point-of-sale device to make on-time bill payments.

In some aspects, the method further includes receiving a purchase request from the customer for at least one item, and wherein the amount paid is further associated with the cost of this item. The receipt may then include an itemized breakdown of the payment amount for both the bill and the item. This may be particularly useful, for example, when the customer is making payment on a bill at a grocery store or other retail location. The customer can select a desired number of items to purchase at the store, and then pay for the items at the same time they are paying for one or more bills, such as their utility bills.

The vendor verification may include transmitting a vendor identification from the point-of-sale device to a host computer and receiving verification from the host computer. The host computer is coupled to a database that has a record of the group of authorizing vendors. In some aspects of the invention, information is received from the customer by scanning a Universal Product Code (UPC), a magnetic stripe, or the like from the customer's bill. The information may include a customer identification number, a vendor identification number, and an amount owed. In one aspect, some or all of this information is encoded in a UPC found on the customer's bill. The payment by the customer may be made using a credit card, personal check, money order, cash, or the like. The payment authorization may similarly comprise a credit card charge authorization, a check authorization, or the like. In this manner, the utility company or other vendor has in effect provided the consumer with greater payment options beyond those typically offered. Further, the utility company is able to take advantage of the point-of-sale payment authorization system, to confirm that the payment is indeed authorized and valid.

In some embodiments, the payment amount paid by the customer is a portion of an amount owed by the customer to the vendor. In some aspects, verifying that the vendor accepts payments from a point-of-sale device may further include verifying that the vendor accepts partial payments for amounts owed. The payments or portions thereof received at the point-of-sale device are transmitted to the vendor, to a host computer, or the like in some embodiments. Payment transfer may be made using the Automated Clearing House (ACH) system, the Western Union Money Transfer System, or some other money transfer system.

The present invention further provides methods of facilitating bill payments by a customer. One such method includes registering a customer using a computer to create a customer account. A plurality of bill information associated with a plurality of vendors is received into the customer account. The method includes calculating, using the computer, a total amount owed by the customer from the plurality of bill information, and providing the customer with the total amount and a transaction identifier. The transaction identifier may, for example, be a UPC, a magnetic stripe, an alphanumeric string of characters, or the like. A payment record is received which includes at least a portion of the total amount. The method includes reporting to the plurality of vendors an amount received for each of the vendors associated with the customer.

In some aspects, at least some of the bill information is received from the customer, and in other aspects at least some of the bill information is received electronically from at least some of the vendors. The bill information may include a vendor identification (e.g., vendor name, vendor code, or the like), a customer vendor account, an amount due from the customer to the vendor, and a due date. The amount due may be the entire amount due or a partial amount due from the customer to the vendor.

The method may further include calculating a due date for a payment of the total amount owed by the customer to the various vendors. In one aspect, the calculated due date is an earliest due date associated with the plurality of bill information. In this manner, a customer payment by the calculated due date will increase the likelihood that all of the bills associated with the received bill information can be timely paid. In one aspect, the customer is provided with the total amount electronically. In another aspect, the payment record is received from a point of sale device, from a host computer system, or the like.

The invention further provides systems for processing payments. One such system includes a host computer adapted to be coupled to a point-of-sale (POS) device. The host computer includes a processor. A database is coupled to the host computer having, in one aspect, a record of a group of authorizing vendors. The host computer further comprises code adapted for performing a variety of processes according to methods of the present invention. For example, in one embodiment the host computer includes code for receiving a vendor identification from the POS device for determining if the vendor is an authorizing vendor, code for returning a response to the POS device, and code for receiving a payment record from the POS device. The payment record may comprise the vendor identification, the customer identification, and/or a payment amount. In some aspects the system further includes code for receiving the payment amount, and forwarding at least a portion of the payment to the vendor. In some embodiments, the point-of-sale device is included with the system.

Other objects, features and advantages of the present invention will become more fully apparent from the following detailed description, the appended claims, and the accompanying drawings.

### BRIEF DESCRIPTION OF THE DRAWINGS

FIG. 1 is a simplified schematic system for processing bill payments according to the present invention;

FIG. 2 is a simplified schematic of a method of processing payments according to an embodiment of the present invention;

FIG. 3 is a simplified schematic system for processing bill payments according to an alternative embodiment of the present invention; and

FIG. 4 is a simplified depiction of a web page screen for implementing portions of a method of the present invention.

### DETAILED DESCRIPTION OF THE INVENTION

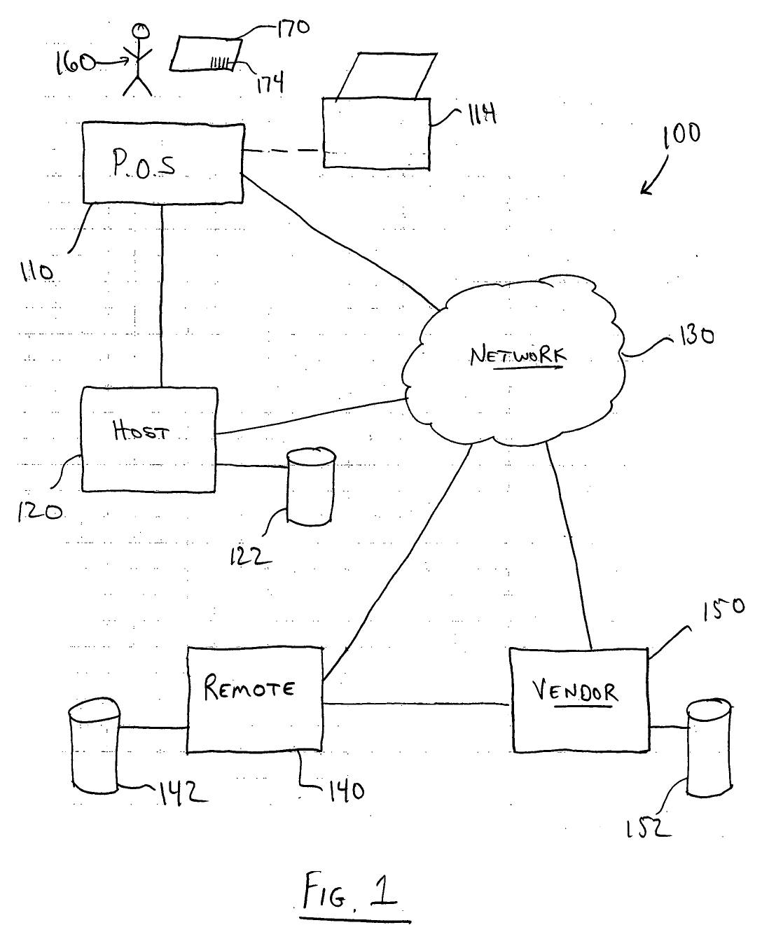

Turning now to FIG. 1, a system 100 for processing bill payments according to an embodiment of the present invention will be described. System 100 includes a host computer 120 coupled to a database 122. Host computer 120 also is coupled to a point-of-sale (POS) device or terminal 110. This coupling may be a direct coupling, or may be an electronic coupling through a network 130. Network 130 may include telephone networks, credit card networks, wide area networks, the Internet, wireless networks, and the like. Further, depending on the type of processing device used to transmit the information, such devices may also be coupled to a financial network such as a credit card network or Automated Teller Machine (ATM) network, or may have a direct connection to other host computer systems. A direct coupling between host computer 120 and point-of-sale device 110 may comprise, for example, a point-of-sale terminal 110 in a store location, physically or wirelessly coupled with host computer 120. In some embodiments, host computer 120 comprises a server, a computer, or the like, such as in a back room of the store. In this embodiment, host computer 120 may be a vendor owned system located at, for example, a grocery store or the like.

Host computer 120 and its associated database 122 may contain a wide variety of store-related records. For example, in some embodiments database 122 contains inventory lists, price lists, vendor lists, employee information and the like. In a particular embodiment, point-of-sale device 110 exists in a grocery store having a plurality of items available for consumers to purchase. Typically, such a point-of-sale device may form part of a cash register system in which the customer, or a clerk or employee of the store scans item UPC's or item information into point-of-sale device 110. Point-of-sale device 110 receives the costs associated with those items from host 120. Point-of-sale device 110 then accumulates a total cost of all items to be purchased by a customer 160 and presents the total to customer 160. The store customer will then tender payment for the desired items and depart the store location. If the payment is rendered using a credit card, a personal check, or the like, a payment authorization process may occur before the user departs with the desired items. This authorization may involve standard credit card authorization or check authentication as known to those skilled in the art. Customer 160 also may pay by cash, money order, travelers check, or the like.

In some embodiments, host computer 120 does not reside at a store location, but instead resides at a regional location. For example, a grocery store chain may have a single regional host server 120 maintaining records of store inventory, and costs and prices associated with items sold therein. The point-of-sale terminals 110 in one or more store locations are coupled to the host server 120. In this manner, inventory and prices can be managed on a regional level in addition to a store by store manner. In still another embodiment, host computer 120 is a third party owned system used to facilitate various transactions. In some cases, host computer 120 resides at a third party transaction processing facility.

In some embodiments, point-of-sale terminal(s) 110 communicate with host computer 120 through network 130. Point-of-sale devices 110 that may be used to capture, transmit and/or receive information to and from host computer system 120 are described in copending U.S. application Ser. No. 10/116,689 filed Apr. 3, 2002, assigned to the assignee of the present invention, the complete disclosure which is herein incorporated by reference. Other ways of transmitting information include by telephone (such as by using an Interactive Voice Response (IVR) system), mobile or wireless devices, by contacting a customer service representative or the like.

In some cases customer 160 purchases items at the store using the above-noted procedure, but also wants to be able to pay for other goods or services that are not associated with that store. In a particular embodiment of the present invention, system 100 is adapted to allow a customer 160 to pay bills at the store location using point-of-sale terminal 110. More specifically, in some embodiments system 100 allows customer 160 to pay credit card bills, mortgage payments, automobile payments, other store credit card payments, utility bills, and the like. In a particular embodiment, customer 160 presents a bill statement 170 to point-of-sale terminal 110 or to a clerk operating point-of-sale terminal 110. In a particular example that will be described in further detail, bill statement 170 is a utility bill owed by customer 160 to a utility company (vendor). In one embodiment, the vendor has a vendor computer system 150 located at a remote location that maintains records of its customers to whom it provides utility services. These customer records may be'stored in a database 152 associated with vendor computer system 150. Typically, customer 160 would receive bill statement 170, such as through the mail, and in turn mail payment back to the vendor. The vendor would then enter the payment record into their vendor system 150 so that the customer account is updated in database 152. The following month, quarter, or appropriate billing cycle, the vendor would mail a new, updated billing statement 170.to customer 160.

Embodiments of the present invention provide customer 160 with additional payment methods to pay the vendor that issued billing statement 170 to customer 160. In a particular embodiment, customer 160 presents a payment request for billing statement 170 to either point-of-sale terminal 110 or a clerk operating point-of-sale terminal 110. Since the billing statement 170 may not be associated with the store operating point-of-sale terminal 110, the clerk and/or point-of-sale terminal 110 will verify vendor participation within a group of authorizing vendors. More specifically, verification will be made that the vendor who issued billing statement 170 is willing to accept payments through a store operating point-of-sale terminal 110. In one embodiment, a list, table, record of the like of authorizing vendors is maintained within database 122 associated with host computer 120. Again, host computer 120 may be maintained on the store premises, at a remote, regional location, or the like. In this embodiment, point-of-sale terminal 110 communicates with host computer 120 to verify that the vendor who issued billing statement 170 to customer 160 is indeed within a group of authorized vendors that will accept payment at point-of-sale terminal 110. If the vendor who issued billing statement 170 is not an authorizing vendor, then customer 160 will be informed they may not make payment at point-of-sale terminal 110 for billing statement 170. Payment will be accepted for items purchased at the store location.

If the vendor who issued billing statement 170 is an authorizing vendor, customer 160 will be so informed. Customer 160 may then, if desired, tender payment to point-of-sale terminal 110 or a clerk operating point-of-sale terminal 110, to pay some or all of the amount due as reflected on billing statement 170. In one embodiment, this will entail customer 160 conveying a customer identification number and a payment amount to point-of-sale terminal 110. This may be a verbal rendering, from which the clerk or customer 160 will key in the appropriate customer identification and payment amount into point-of-sale terminal 110. Alternatively, some or all of the customer identification and payment amount information is maintained on billing statement 170, such as in a Universal Product Code (UPC) 174. Alternatively, a magnetic strip may be provided on billing statement 170 having appropriate information. Information maintained in UPC 174, the magnetic strip, written or printed on billing statement 170, or the like, may include the customer identification, the payment amount due (a minimum amount and/or a total amount), vendor information, and the like.

The customer identification may be a customer name, a customer address, a customer telephone number, or other identifying information. In one embodiment, the customer identification is an account number assigned to the customer by the vendor. The vendor information may include a vendor name, a vendor identification number, and/or a routing number associated with the vendor. The vendor routing number may be necessary, for example, so that payments received at point-of-sale terminal 110 are appropriately routed to either vendor system 150 or a banking institution at which the vendor has an associated account.

In some embodiments, the portion of billing statement 170 presented to the clerk operating POS device 110 allows the clerk to read only the total amount owed and the customer name. Information on the customer's account with the vendor (e.g., whether the account is delinquent or the like) is not shown to the clerk. In this manner, some degree of security and/or privacy is maintained for customer 160. The presentable portion of billing statement 170 may, for example, be a separate bill page, a tear away strip of the bill, or the like. In other embodiments, UPC 174 contains the vendor information, and the vendor verification process does not identify the vendor on POS device 110. Instead, POS device 110 is merely given the approval to proceed if the vendor is an authorized vendor. In this manner, the vendor of the goods and/or services to customer 160 is not disclosed to the store or the clerk operating POS device 110.

In one embodiment, a remote computer 140 and an associated database 142 maintains some or all of the records identifying the group of authorizing vendors. In this embodiment, point-of-sale terminal 110 communicates via network 130 to remote computer 140 to identify whether the vendor that issued billing statement 170 is included within a group of authorizing vendors.

When customer 160 tenders payment for items purchased at the store and/or for an amount owed as reflected on billing statement 170, this payment may require further authorization. For example, if customer 160 is paying with a credit card, a standard credit card authorization may be performed using point-of-sale terminal 110. Similarly, if customer 160 is paying with a personal check, a check authentication process may be performed at point-of-sale terminal 110. In another embodiment, remote computer 140 assists with the authentication and/or authorization processes in the event customer 160 is tendering payment for billing statement 170. In this embodiment, remote computer 140 may identify customer 160 using a customer identification number, and determine by using records maintained in database 142 that customer 160 is approved for paying billing statement 170 at remote point-of-sale terminals, such as point-of-sale terminal 110. In some embodiments, customer 160 will be tendering payment only for billing statement 170. In other embodiments, customer 160 will be tendering payment for some or all of the amount identified in billing statement 170 and also additional items purchased at the store location operating point-of-sale terminal 110. In this manner, customer 160 may kill two birds with one stone by, for example, purchasing desired groceries or other items available at a store as well as paying one or more bills such as billing statement 170.

In some embodiments, payment received by point-of-sale terminal 110 as partial or full payment for billing statement 170 is forwarded to vendor system 150 using an Automated Clearing House (ACH) system and process. In some embodiments, remote computer 140 controls or helps control the ACH process for payments received by customer 160 that are associated with billing statements 170. In this embodiment, remote computer 140 may control the money transfer process so that money collected by point-of-sale terminal 110 is appropriately routed to the desired vendor or vendor system 150. Additional details on money transfers for use with the present invention may be found in U.S. application Ser. No. 10/356,207, filed Jan. 30, 2003, entitled Financial Settlement Systems and Methods; and U.S. application Ser. No. 10/286,006, filed Nov. 1, 2002, entitled Stored Value Currency Conversion Systems and Methods, both assigned to the assignee of the present, and the complete disclosures of which are herein incorporated by reference.

In some embodiments, customer 160 desires to make a partial payment on the amount owed according to billing statement 170. In this embodiment, the vendor verification process may further include identifying whether the vendor will accept partial payments. Again, the verification process may involve interaction between point-of-sale terminal 110, host computer 120, and/or the interaction between point-of-sale terminal 110 and remote computer 140.

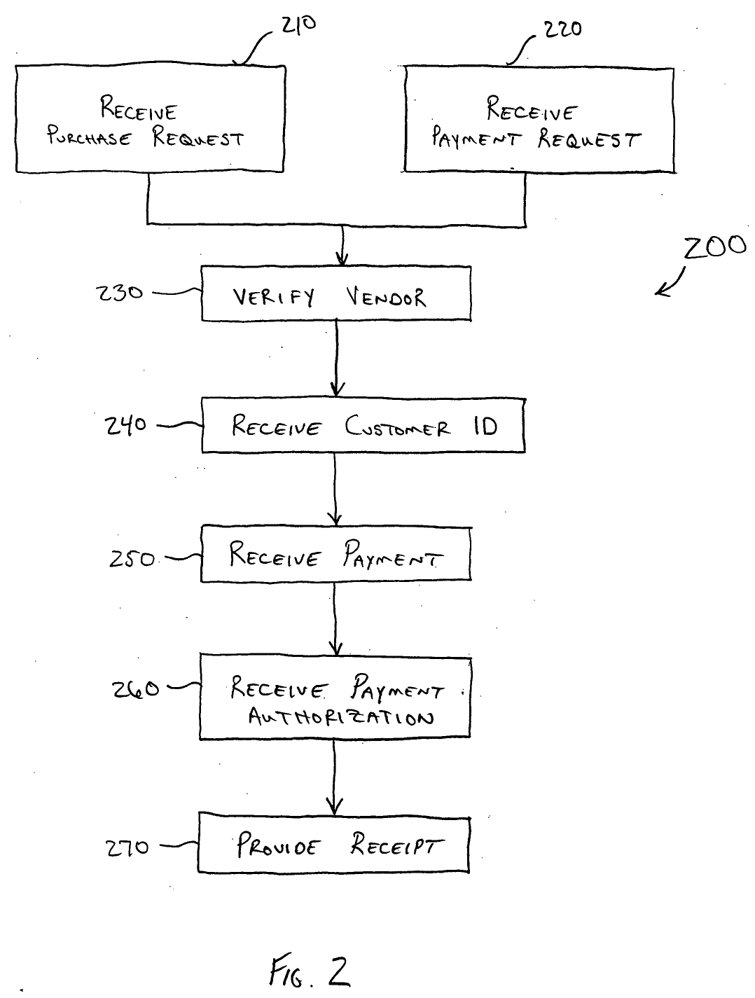

Turning now to FIG. 2, a particular embodiment of a method according to the present invention will be described. Method 200 includes receiving a purchase request (Block 210). In one embodiment, this involves a customer of a grocery store, drug store, department store, or the like, selecting the desired number of items to be purchased that are the subject of the purchase request. The items are then presented at a check-out location, point-of-sale terminal, or the like. The method includes receiving a payment request (Block 220). The customer issues the payment request so that they can pay one or more bills associated with a vendor. The vendor may, or may not be associated with the store, merchant or entity operating point-of-sale terminal 110. Method 200 includes verifying the vendor (Block 230). As previously noted, this includes verifying that the vendor participates in the program or system that approves a payment of bills via remote terminals. In one embodiment, appropriate software is maintained on host computer 120 and/or remote computer 140 or their associated databases 122, 142, to perform the vendor verification process as well as other portions of method 200.

Method 200 includes receiving a customer identification (Block 240) and receiving a payment (Block 250). The customer identification may include a customer account number associated with the vendor for which the customer desires to pay their bill, or some other identification. The payment received may include a payment for both the bill that is the subject of the payment request, and also the items that are the subject of the purchase request. The payment amount may also be for just the bill in one embodiment. This may occur, for example, if the customer wants to pay their billing statement 170 using one form of payment (e.g., credit card, check, etc.), and to pay for the store items using a different form of payment (e.g., cash, money order, etc.), or is paying with the same payment form but desires two separate payment records. A payment authorization is received (Block 260) and a receipt (Block 270) is provided to the customer. In one embodiment, the receipt provided to the customer is an itemized receipt showing a breakout of not only the items that are the subject of the purchase request, but also the amount paid toward the bill(s) that is the subject of the payment request.

The advantages of the present invention, including the examples described in conjunction with FIGS. 1 and 2, are numerous. For the consumer, the consumer now has multiple locations at which they can pay their bills. The consumer may multi-task by paying bills at a location at which they had already planned to purchase groceries or the like. The consumer does not need to purchase a stamp or go through the time and hassle of mailing a payment back to the vendor, utility, or the like. Further, through the payment authorization process, the payment is authenticated on the date the payment is tendered. In this manner, the customer does not run the risk that the U. S. Postal Service will lose the mailed payment, rendering the customer delinquent on their account and subject to associated late fees, interest charges, or the like. The customer may further be provided with peace of mind by receiving a receipt from point-of-sale terminal 110. This receipt may be printed on a printer 114 as reflected in FIG. 1. Further, the customer avoids the hassles of calling their utility company and authorizing a single debit to a checking or savings account via the telephone, which some utilities currently allow. Instead, system 100 and/or the clerk operating POS 110 performs most of the tasks of transmitting required information from billing statement 170 to the appropriate computer systems 120, 140, 150 for authorization and tendering of payment. The customer further can avoid bill payment websites on the Internet that cause the consumer concern with respect to security, or other issues.

Benefits to the vendor are numerous as well. For example, in one aspect there is less payment risk associated with the present invention. In particular, point-of-sale device 110 can facilitate payment authorization through the credit card authorization and check authentication processes. The vendor will receive payments from the retailer more quickly through the ACH or other money transfer process compared to waiting for the mailed payment from the customer. The vendor further benefits by having customers who are satisfied at having additional payment options.

Benefits to the merchant operating the point-of-sale terminal also exist. First, the merchant, by participating in this process, is providing an additional service to customers which their competitors may not. This could increase consumer traffic to their store locations. For example, while the above examples describe the user proceeding to a grocery store to purchase items and at the same time paying their bill(s), the reverse may happen. For example, the user may proceed to the grocery store to pay their bills and while they are there purchase a few items. In addition to the possibility of additional purchases, increased revenue may be received by the merchant through commissions paid by the customer and/or the vendor. In one embodiment, the vendor pays a small fee to the merchant for each bill paid at the merchant location. In another embodiment, the customer pays a charge to the vendor and/or merchant for the convenience of paying bills at the point-of-sale terminal. Still another advantage to the merchant would be the float available to the merchant. The merchant may have in their account the money associated with the bills paid by their customers for a period of time before transmission of the money to the appropriate vendors. It will be appreciated by those skilled in the art that additional benefits to each of the parties of the methods of the present invention, arising from one or more components of the systems of the present invention may be realized within the scope of the present invention.

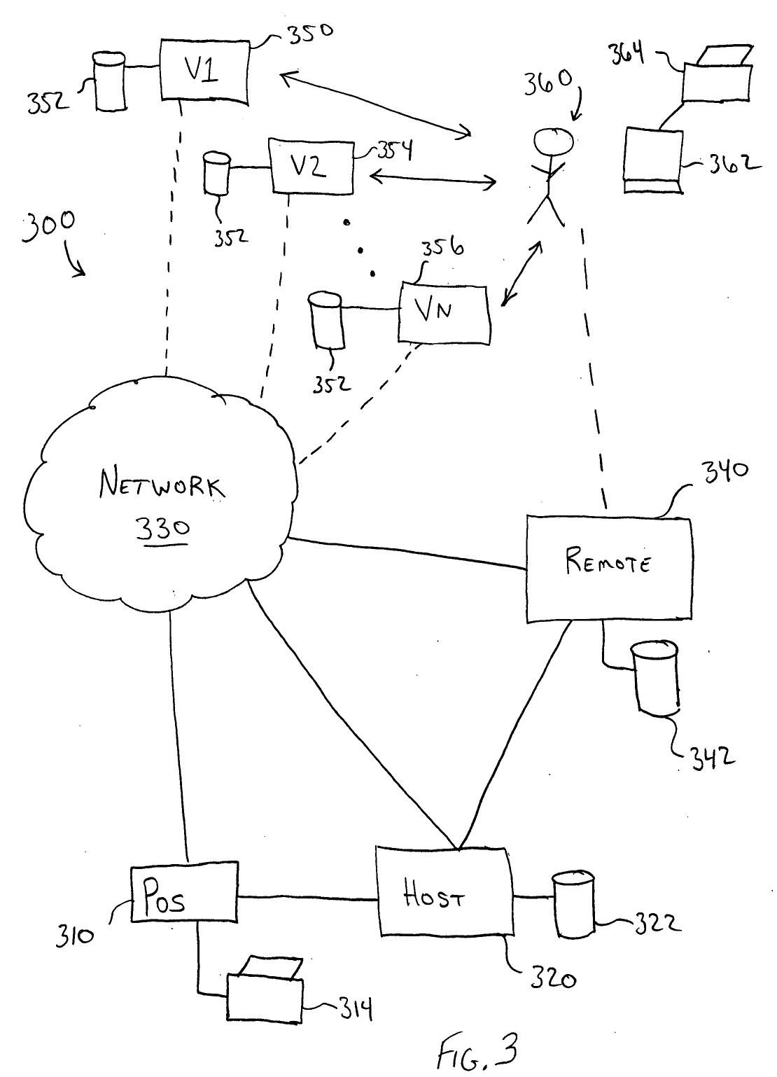

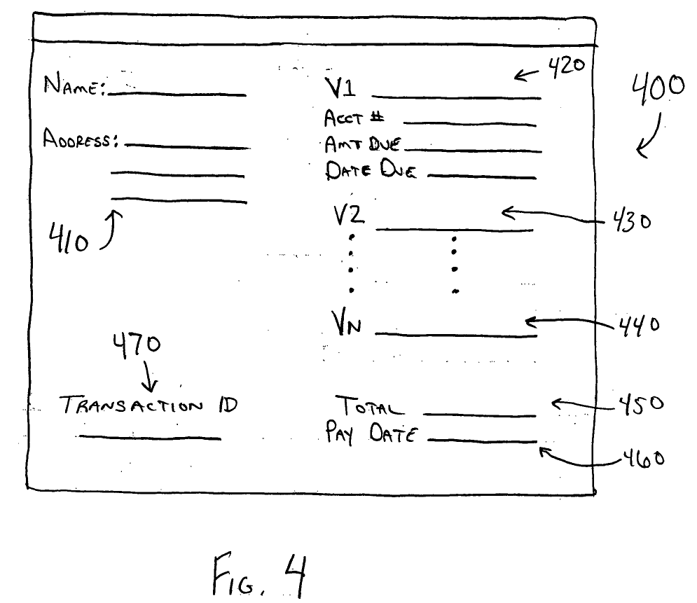

Turning now to FIGS. 3 and 4, an alternative embodiment of a system 300 and methods of use according to the present invention will be described. System 300 includes a number of the same or similar components as described in conjunction with FIG. 1. For example, system 300 includes a point-of-sale (POS) device 310 coupled to a host computer 320. POS device 310 may be a point-of-sale terminal at a grocery store, or other retail outlet, and host computer 320 may comprise a computer, server, or the like associated with that store or retail outlet. Point-of-sale device 310 has a printer 314 coupled thereto for printing, for example, receipts of transactions performed using POS device 310. Host computer 320 is coupled to a database 322. Database 322 is used to store information necessary or useful for the retail outlet, including without limitation customer account information, store inventory, product pricing, employee information, and the like. In some embodiments, POS device 310, host computer 320 and database 322 are similar or identical to point-of-sale device 110, host computer 120 and database 122, respectively.

A remote computer 340 having an associated database 342 is included in one embodiment. Remote computer 340 and database 342 may be similar or identical to remote computer 140 and database 142 described in conjunction with FIG. 1. Remote computer 340 may, for example, facilitate transactions performed at the retail location associated with point-of-sale device 310. Database 342 contains, for example, customer account and authorized vendor information as described in conjunction with earlier Figures. Remote computer 340 may be directly coupled to host computer 320 and/or POS device 310, or may be coupled thereto through a network 330 similar to network 130.

A user or customer 360 of system 300 may be the same as or similar to user/customer 160. In this embodiment, however, user 360 wishes to pay a number of bills owed to various vendors V1, V2 through VN. The vendors may include any number of goods and/or service providers, including for example utility companies, credit card companies, mortgage companies, retail store credit companies, health clubs, automobile leasing or lending institutions, newspapers, magazine providers, and the like. In a particular embodiment, user 360 desires to pay multiple bills in a single payment or transaction. User 360 uses system 300 to accomplish some or all of these goals as further detailed herein.

In the depicted example, user 360 has a first vendor 350, a second vendor 354, up to an N^{th} vendor 356 to which they owe money for goods and/or services provided by the vendors. The goods and services may be provided directly to user 360, or may be provided to a third party for which user 360 has agreed to pay. Typically, vendors 350, 354, 356 will expect payment from user 360 in a designated time interval or billing cycle (monthly, quarterly, or the like). User 360 may, for example, receive a mailed billing statement from each vendor, and remit payment to these vendors individually such as by mailing a check, money order, or other accepted form of payment. Each vendor 350, 354, 356 may have a database 352 associated therewith for maintaining customer records. For example, user 360 may have an associated database entry in databases 352 for each of the vendors providing goods or services to user 360. User 360 may interact with one or more vendors 350, 354, 356, using a personal communication device, which in one embodiment is a computer 362. This interaction may involve accessing a password protected web page to view the status of an account user 360 has with the vendor. In one embodiment, user communication device 362 has a printer 364 coupled thereto so that user 360 may print desired customer or account information.

In one embodiment, user 360 wishes to pay bills associated with vendors V1 and V2 while shopping at a grocery store associated with point-of-sale device 310. This may occur in a manner similar to that described in conjunction with FIGS. 1 and 2. In a particular embodiment, user 360 desires to pay a plurality of bills in a single transaction while at a retail location or other location containing point-of-sale device 310. This method will be further described in conjunction with FIG. 4.

In one embodiment, remote computer system 340 is operated by a third party vendor such as Western Union, or the like. Remote system 340 provides a bill paying service so that user 360 can pay a variety of bills while user 360 is either shopping at a location having POS device 310, or at some other point-of-sale device not necessarily associated with a retail location. User 360 registers with the third party entity controlling remote computer system 340. In a particular embodiment, the registration process occurs via a password protected website using a webpage 400 such as depicted in FIG. 4. User 360 creates an account on website 400 hosted by remote computer 340, which may include establishing a user identifier and password. User 360 then is able to input desired information into their account created by remote computer system 340 to help consolidate bill payment. For example, as shown in FIG. 4, user 360 inputs user information 410, such as a user name and address. Other information also may be input and/or required such as a social security number, credit card number, driver's license number, or the like. User 360 then inputs information on various vendors to which user 360 desires to make payment. For example, user 360 may have a first vendor, a second vendor, up to an N^{th} vendor for which they want to pay bills at various POS devices 310. In this embodiment, user 360 inputs vendor V1 information 420, vendor V2 information 430, and vendor VN information 440. The information may be uniform for each vendor, or may vary from vendor to vendor. For example, vendor V1 may have assigned user 360 with an account number for use within vendor system 350. Utility companies typically establish an account number for each customer for which they are providing utility service. In this embodiment, the account number user 360 has with that utility vendor V1 is part of the information 420 input into screen 400. User 360 may further input an amount due and a date upon which the amount is due for a particular vendor billing cycle (e.g., monthly). In one embodiment, this information 420-440 for vendors V1-VN is entered into the password protected website 400 by user 360. This may occur, for example, when user 360 reads their monthly billing statements received in the mail from vendors V1-VN, and types in bill information 420-440 into website 400. Other data entry methods may be used by user 360, including providing data by telephone to a customer service agent of remote system 340, voice recognition software, and the like.

In one embodiment, remote computer system 340 calculates a total amount due 450 and a pay date 460. Pay date 460 may, for example, comprise the earliest due date associated with billing information 420-440 in a particular billing cycle. For example, if vendor V1 requires payment on the 15th of the month, vendor V2 requires payment on the 20th of the month, and the third and final vendor VN requires payment on the 21st of the month, a designated pay date 460 may be the 15th of the month. In this manner, paying the total 450 on pay date 460 will increase the likelihood or help ensure that all of the vendors V1-VN will be paid on time.

In one embodiment, the total amount due 450 and the pay date 460 associated therewith are coupled with a transaction identifier (ID) 470. In one embodiment, transaction ID 470 is an alphanumeric string of characters associated with total amount due 450 and user 460. In one embodiment, transaction ID 470 is a UPC or other transaction indicator having stored therein a payment amount which may be associated with or the same as total amount due 450, user identification information, and/or pay date 460. In other embodiments, a single identifier, an account number, a fingerprint, or the like, is assigned and/or associated with user 360's vendor V1-VN account profile(s). In one embodiment, the account number, or the like, is embedded into a radio frequency identification (RFID) enable device which would be read by an RFID reader device. The reader device would send a request to a host database, which maybe database 322, 342 and/or 352 for cross reference and a response that includes transaction ID 470.

Transaction ID 470 is made available to user 360 on password-protected website 400, or alternatively is sent to user 360 using an email, electronic message, page, phone call, and/or a physical mailing. Additional information also may be sent to user 360 or made available to user 360, including amount due 450 and/or pay date 460. For example, user 360 may optionally provide or be required to provide an email address during the registration or login process into system 340. Remote computer system 340 then sends an email to user 360 providing transaction ID 470, total amount due 450, and/or pay date 460. If desired, user 360 may print this information using printer 364. User 360 presents or provides transaction ID 470 to POS device 310 or a clerk operating POS device 310 for payment of the vendor accounts associated with total 450.

The presentation and payment may occur in a manner similar or identical to the payment methods described in conjunction with FIG. 1. For example, the clerk operating POS device 310 may scan in transaction ID 470 into point-of-sale device 310 and collect payment in the amount equivalent to total amount due 450, or the amount equivalent to total 450 plus any additional amount required for user 360 to purchase items at a retail location at which POS device 310 resides. A record of a portion of the payment received from user 360 will be forwarded to remote computer system 340. Actual payment may follow using ACH procedures, or the like, for subsequent distribution to the various vendors. For example, total amount due 450 may be calculated to be six hundred dollars ($600) if user 360 indicates it owes vendor V1 one hundred dollars ($100), vendor V2 two hundred dollars ($200), and vendor V3 three hundred dollars ($300). User 360 then pays six hundred dollars ($600) at POS device 310, plus the costs of other items purchased by user 360 at the retail outlet. The $600 is transmitted to remote computer system 340, and system 340 operates to ensure that vendor V1 receives one hundred dollars ($100), vendor V2 receives two hundred dollars ($200), and vendor V3 receives three hundred dollars ($300), and indicate to the vendors that user 360 is the source of the funds. Further, remote computer system 340 may charge a transaction processing fee in addition to the vendor-owed amounts, which would be collected from user 360 at POS device 310. In one embodiment, transaction charges, if any, are maintained in host database 322 and/or remote database 342 for access by POS device 310 during a transaction for user 160.

In another embodiment, the vendor accounts user 360 has with vendors V1-VN are linked directly to remote computer system 340. In this embodiment, the amounts owed by user 360 to, for example, vendor V1 may be electronically forwarded directly to remote computer 340 and entered into the account user 360 has with remote computer 340. In this manner, the amount(s) owed by user 360 to vendors V1-VN are populated into a database entry associated with user 360. System 340 then computes total amount due 450 and pay date 460. This electronic transfer of amounts owed by user 360 to the various vendors V1-VN may occur in parallel with the mailing of billing statement from the vendors to user 360. Alternatively, only the electronic transfer of the amount owed is transferred to user 360 account in remote computer system 340. In this manner, if desired, user 360 can log onto the password protected website 400 to check the amount(s) owed and the date(s) on which they are owed, as reflected in information 420-440, prior to heading to the grocery store or other location having POS device 310.

It will be appreciated by those skilled in the art that alternative methods of using system 300 fall within the scope of the present invention. For example, the entry of data into web page 400 may occur a single time, for a single total payment calculation for user 360. This may be useful, for example, if user 360 is intending to be out of town and wants to pay their bills prior to departure. Alternatively, some or all of the amounts owed to vendors V1-VN may be identical from month to month. This may occur, for example, if vendors V1-VN are financial institutions that have lent money to customer 360 for the purchase of homes, automobiles, or the like, as such vendors may be more likely to have a fixed amount owed by customer 360 for each billing cycle (e.g., monthly). Further, in one embodiment, web page 400 is adapted to receive revised amounts from user 360. This may be beneficial, for example, if user 360 is able to or desires to pay only a portion of the amount owed to vendor V1, but wants to at least make a partial payment. This may be particularly useful, for example, when vendor V1 has lent money to user 360, so that even a partial payment helps reduce the accrued interest on subsequent payments. In one embodiment, remote system 340 verifies whether vendor V1 will accept partial payments by accessing information related to vendor V1 in database 342, by communicating with vendor V1 system 350, or the like. Methods of using system 300, in some embodiments, are software based. Software residing on remote computer 340, database 342, host computer 320, database 322, vendor systems and their databases 350-356 each may comprise some or all of the associated software for performing various processes and steps of methods of the present invention.

The invention has now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific examples, but rather is to be accorded in the scope represented in the following claims.

What is claimed is:

1. A method of processing payments, the method comprising:
receiving a purchase request from a customer, the purchase request for at least one consumer item;
receiving a payment request from the customer, the payment request for a bill associated with a vendor;
verifying, using a point-of-sale device, the vendor is included in a group of authorizing vendors;
receiving a customer identification from the customer associated with the bill;
receiving a payment amount from the customer, the payment amount associated with the bill and with a cost of the at least one consumer item;
receiving a payment authorization; and
providing a receipt to the customer.

2. The method as in claim 1 wherein the receipt comprises an itemized breakdown of the payment amount for the bill and for the at least one item.

3. The method as in claim 1 wherein verifying the vendor comprises transmitting a vendor identification from the point-of-sale device to a host computer, the host computer coupled to a data base having a record of the group of authorizing vendors, and receiving confirmation at the point-of-sale device from the host computer that the vendor is included in the group of authorizing vendors.

4. The method as in claim 1 wherein receiving the customer identification comprises scanning a UPC code from the bill.

5. The method as in claim 4 further comprising receiving a vendor identification from the UPC code.

6. The method as in claim 1 wherein the payment comprises a payment from the customer using a credit card, and wherein the payment authorization comprises a credit card charge authorization.

7. The method as in claim 1 wherein the payment comprises a payment from the customer using a personal check, and wherein the payment authorization comprises a check authorization.

8. The method as in claim 1 wherein receiving the payment request comprises receiving a bill statement from the customer, and wherein verifying the vendor comprises receiving a vendor identification from the bill statement using the point-of-sale device and sending the vendor identification from the point-of-sale device to a host computer.

9. The method as in claim 1 wherein the payment amount is a portion of an amount owed by the customer to the vendor as indicated on the bill statement.

10. The method as in claim 9 wherein verifying the vendor further comprises verifying the vendor accepts a partial payment of the amount owed by the customer.

11. The method as in claim 1 further comprising transmitting a portion of the payment amount to the vendor.

12. The method as in claim 1 further comprising transmitting a record of the payment amount to a host computer.

13. A method of facilitating bill payments by a customer, the method comprising:
registering a customer using a computer to create a customer account;
receiving a plurality of bill information into the customer account, the bill information associated with a plurality of vendors;
calculating using the computer a total amount owed by the customer from the plurality of bill information;
providing the customer with the total amount and a transaction identifier;
receiving a payment record, the payment record including at least a portion of the total amount; and
reporting to the plurality of vendors an amount received for each of the plurality of vendors associated with the customer.

14. The method as in claim 13 wherein the receiving of the plurality of bill information comprises receiving at least some of the plurality of bill information from the customer.

15. The method as in claim 13 wherein the receiving of the plurality of bill information comprises receiving at least some of the plurality of bill information electronically from at least some of the plurality of vendors.

16. The method as in claim 13 wherein the bill information includes a vendor identification, a customer vendor account, an amount due from the customer to the vendor, and a due date.

17. The method as in claim 16 wherein the amount due is a partial amount due from the customer to the vendor.

18. The method as in claim 13 further comprising calculating a due date for a payment of the total amount owed by the customer.

19. The method as in claim 18 wherein the calculated due date is an earliest due date associated with the plurality of bill information.

20. The method as in claim 13 wherein providing the customer with the total amount comprises electronically providing the customer with the total amount.

21. The method as in claim 13 wherein the transaction identifier comprises a UPC.

22. The method as in claim 13 wherein receiving the payment record comprises receiving the payment record from a point of sale device.

23. A system for processing bill payments, comprising:
a host computer adapted to be coupled to a point-of-sale device, the host computer having a processor and coupled to a data base having a record of a group of authorizing vendors;
wherein the host computer further comprises:
code for receiving a vendor identification from the point-of-sale device;
code for determining if the vendor identification is included in the record of the group of authorizing vendors;
code for returning a response to the point-of-sale device; and
code for receiving a payment record from the point-of sale device, the payment record comprising the vendor identification, a customer identification and a payment amount.

24. The system as in claim 23 wherein the host computer further comprises code for receiving the payment amount and forwarding at least a portion of the payment amount to the vendor.

25. The system as in claim 23 further comprising the point-of-sale device.
